(19) United States
(12) Patent Application Publication
(10) Pub. No.: US 2025/0076519 A1
(43) Pub. Date: Mar. 6, 2025

(54) POSITIONING APPARATUS

(71) Applicant: SEIKO EPSON CORPORATION, Tokyo (JP)

(72) Inventor: Tomoya KAWAMOTO, MATSUMOTO-SHI (JP)

(73) Assignee: SEIKO EPSON CORPORATION, Tokyo (JP)

(21) Appl. No.: 18/824,853

(22) Filed: Sep. 4, 2024

(30) Foreign Application Priority Data
Sep. 6, 2023 (JP) 2023-144220

(51) Int. Cl. G01S 19/30; G01S 19/34

(52) U.S. Cl. CPC G01S 19/30; G01S 19/34

(57) ABSTRACT

A positioning apparatus includes a positioning unit configured to receive a satellite signal transmitted from each of a plurality of satellites, decode positioning data included in the satellite signal, and perform positioning based on the positioning data decoded, the positioning data being predetermined data required for calculation of a position of the satellite and a distance from the satellite, and a control unit configured to control the positioning unit regarding whether the positioning is continued or stopped, based on a decode completion rate of the positioning data by the positioning unit.

The present application is based on, and claims priority from JP Application Serial Number 2023-144220, filed Sep. 6, 2023, the disclosure of which is hereby incorporated by reference herein in its entirety.

### BACKGROUND

### 1. Technical Field

The present disclosure relates to a positioning apparatus.

### 2. Related Art

An electronic apparatus is known that includes a GPS unit that receives radio waves from a positioning satellite, a GPS information acquiring unit that acquires ephemeris information with the GPS unit and acquires satellite placement information of each of a plurality of positioning satellites for which the ephemeris information is acquired, a sensor information acquiring unit that acquires location condition information of the current location, and a reception condition determination unit that specifies the number of positioning satellites that can be captured at the current location among the plurality of positioning satellites for which the ephemeris information is acquired on the basis of the location condition information of the current location and the satellite placement information. The electronic apparatus disclosed in JP-A-2020-170007 turns off the reception at the GPS unit and performs switching to autonomous navigation when a predetermined number or more pieces of the ephemeris data information is acquired.

The electronic apparatus disclosed in JP-A-2020-170007, however, does not turn off the reception at the GPS unit when the predetermined number or more pieces of ephemeris data information cannot be acquired, and as such it takes long time to acquire all ephemeris data when the communication environment is poor, which leads to a large power consumption at the GPS unit.

### SUMMARY

A positioning apparatus according to the present disclosure includes a positioning unit configured to receive a satellite signal transmitted from each of a plurality of satellites, decode positioning data included in the satellite signal, and perform positioning based on the positioning data decoded, the positioning data being predetermined data required for calculation of a position of the satellite and a distance from the satellite, and a control unit configured to control the positioning unit regarding whether the positioning is continued or stopped, based on a decode completion rate of the positioning data by the positioning unit.

### BRIEF DESCRIPTION OF THE DRAWINGS

FIG. 1 is a diagram illustrating an example of a configuration of a positioning apparatus of a first embodiment.

FIG. 2 is a diagram illustrating a configuration of a navigation message in a GPS.

FIG. 3 is a diagram illustrating an example of a configuration of decode status information.

FIG. 4 is a diagram illustrating an example of a configuration of a positioning unit.

FIG. 5 is a diagram illustrating an example of a period, a timeout time, and an extension time of an intermittent drive of the positioning unit of the first embodiment.

FIG. 6 is a flowchart illustrating an example of a generation procedure of decode status information by the positioning unit.

FIG. 7 is a flowchart illustrating an example of a positioning control procedure by a control unit of the first embodiment.

FIG. 8 is a flowchart illustrating an example of a procedure of a process of step S107 of FIG. 7.

FIG. 9 is a diagram illustrating an example of a relationship between an elapsed time and a positioning stop condition in a second embodiment.

FIG. 10 is a diagram illustrating an example of a period, a timeout time and a positioning stop timing of an intermittent drive of a positioning unit of the second embodiment.

FIG. 11 is a diagram illustrating an example of a period, a timeout time, and an extension time of an intermittent drive of the positioning unit of the second embodiment.

FIG. 12 is a flowchart illustrating an example of a positioning control procedure of a control unit of the second embodiment.

FIG. 13 is a flowchart illustrating an example of a procedure of a process of step S128 of FIG. 12.

FIG. 14 is a diagram illustrating an example of a relationship between a remaining capacity of a battery, an elapsed time and a positioning stop condition in a third embodiment.

FIG. 15 is a flowchart illustrating an example of a positioning control procedure of a control unit of the third embodiment.

FIG. 16 is a flowchart illustrating an example of a procedure of a process of step S128 of FIG. 15.

### DESCRIPTION OF EMBODIMENTS

Preferred embodiments of the invention will be described in detail below using the drawings. The embodiments described below do not unduly limit the contents of the invention described in the claims. Also, not all of the configurations described below are essential to the invention.

### 1. First Embodiment

### 1-1. Configuration of Positioning Apparatus

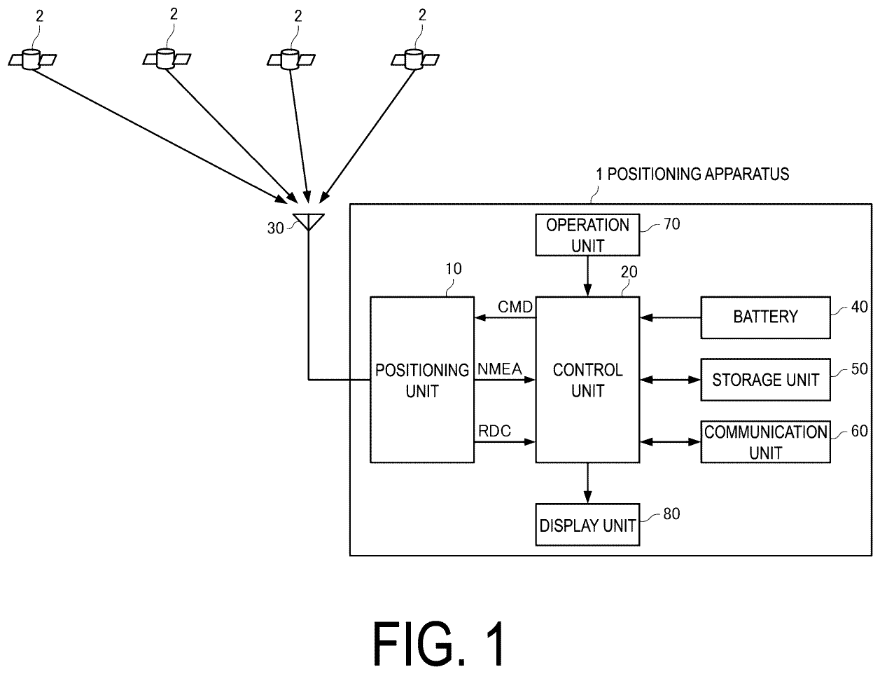

FIG. 1 is a diagram illustrating an example of a configuration of a positioning apparatus 1 of this embodiment. The positioning apparatus 1 receives a satellite signal transmitted from satellite 2, and performs positioning based on the received satellite signal as elaborated below.

As illustrated in FIG. 1, the positioning apparatus 1 of this embodiment includes a positioning unit 10, a control unit 20, an antenna 30, a battery 40, a storage unit 50, a communication unit 60, an operation unit 70 and a display unit 80. It should be noted that the positioning apparatus 1 may have a configuration in which some of components in FIG. 1 is omitted or changed, or a configuration with other components added to the components in FIG. 1. Note that some or all of the components of the positioning apparatus 1 may be physically separated or integrated. For example, the positioning unit 10 and the control unit 20 may be composed of separate respective ICs, or the positioning unit 10 and the control unit 20 may be composed of a single chip IC. IC is an abbreviation for Integrated Circuit.

Each unit of the positioning apparatus 1 operates with the power supplied from the battery 40. The control unit 20 may control the power supply from the battery 40 to each unit.

The antenna 30 is an antenna that receives various radio waves including a satellite signal transmitted from each of a plurality of satellites 2, and is coupled to the positioning unit 10. The positioning unit 10 receives a satellite signal transmitted from each of the plurality of satellites 2 through the antenna 30, decodes positioning data that is predetermined data included in the received satellite signal and required for the calculation of the position of the satellite 2 and the distance from the satellite 2, and performs positioning based on the decoded positioning data.

The satellite 2 is an artificial satellite orbiting on a predetermined orbit above the earth, and makes up a part of a satellite system. The satellite system to which the satellite 2 belongs may be a GNSS. GNSS is an abbreviation for Global Navigation Satellite System. Examples of the GNSS may include a GPS, a QZSS, an EGNOS, a GLONASS, a GALILEO, and a BeiDou. GPS is an abbreviation for Global Positioning System. QZSS is an abbreviation for Quasi Zenith Satellite System. EGNOS is an abbreviation for European Geostationary Navigation Overlay Service. GLONASS is an abbreviation for Global Navigation Satellite System. In the following description, a case where the satellite system to which the satellite 2 belongs is the GPS is described as an example.

The satellite 2 transmits to the ground satellite signals with navigation messages superimposed on 1.57542 GHz radio waves. In the GPS, there are approximately 30 satellites 2, and each satellite 2 superimposes on the satellite signal the pattern specific to the 1023 chip called C/A code in order to identify the satellite 2 that has transmitted the satellite signal. C/A is an abbreviation for Coarse/Acquisition Code. The C/A code appears to be a random pattern, with each chip being either +1 or −1, and is repeated in 1 ms cycles. Thus, the positioning unit 10 can detect the C/A code superimposed on the satellite signal by correlating the satellite signal and the pattern of each C/A code.

The satellite signal transmitted by each satellite 2 includes orbit information representing the position of each satellite 2 on the orbit. In addition, each satellite 2 includes an atomic clock mounted therein, and the satellite signal includes significantly accurate time information timed by the atomic clock. Thus, the positioning unit 10 receives satellite signals from the four or more satellites 2 and performs positioning calculation using the orbit information and time information included in each satellite signal, and thus, accurate information about the time and the position of the reception point that is the location of the antenna 30 can be acquired. More specifically, the positioning unit 10 needs only to formulate a four-dimensional equation with the three-dimensional position (x, y, z) of the receiving point and time t as four variables and find its solution.

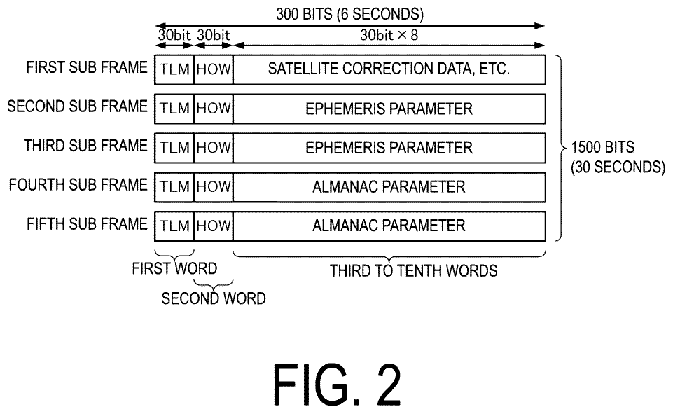

FIG. 2 is a diagram illustrating a configuration of a navigation message in a GPS. As illustrated in FIG. 2, the navigation message in the GPS is configured as data with a mainframe of 1500 total bits as one unit. From the top, the main frame is divided into first to fifth sub frames that are five sub 300-bit frames. The data of one sub frame is transmitted from each satellite in 6 seconds. Thus, the data of one main frame is transmitted from each satellite 2 in 30 seconds.

From the top, the 300-bit data included in each of the five sub frames is divided into first to tenth words with 30 bits as one word. In each sub frame, the first word is TLM word, and the second word is HOW word. TLM is an abbreviation for TeLeMetry, and HOW is an abbreviation for Hand Over Word. Thus, the TLM word and the HOW word are transmitted from the satellite 2 at an interval of six seconds.

The TLM word includes preamble data, TLM message, Reserved bit, and parity data.

The HOW word includes time information that is TOW (Time of Week) or Z count. TOW is an abbreviation for Time Of Week. Z-count data indicates in seconds the elapsed time from 0 o'clock of every Sunday and returns to zero at 0 o'clock of the next Sunday. Specifically, the Z-count data is second-by-second information from the start of a week for each week with the elapsed time indicated on the 1.5-second unit basis. Here, the Z-count data indicates time information about the time when the first bit of the next sub frame data is transmitted. For example, the Z-count data of the first sub frame indicates time information of the time when the first bit of the second sub frame is transmitted. In addition, the HOW word includes 3-bit ID code representing the ID of the sub frame. Specifically, the HOW words of the first to fifth sub frames include ID codes of “001”, “010”, “011”, “100”, and “101”, respectively.

The positioning unit 10 can calculate the time of the satellite 2 by acquiring the week number data included in the first sub frame and the HOW word included in each sub frame. Note that the positioning unit 10 can acquire the current week number data of the satellite 2 without acquiring the week number data each time by previously acquiring the week number data and counting inside the elapsed time from the time when the week number data is acquired. Thus, the current time of the satellite 2 can be determined through rough estimation by only acquiring the Z-count data.

The third word to the tenth word of the first sub frame include the week number, the state of the satellite 2, and satellite correction data such as clock correction coefficients. Specifically, the week number and the state of the satellite 2 are included in the third word, and the clock correction coefficient are included in the eighth to tenth words. The third to tenth words of each of the second and third sub frames include ephemeris parameters that are specific orbit information of the satellite 2. The third to tenth words of each of the fourth and fifth sub frames include almanac parameters that are rough orbit information of all satellites 2. Thus, the satellite correction data, the ephemeris parameter, and the almanac parameter are transmitted at an interval of 30 seconds from the satellite 2.

20-word data composed of the third and eighth to tenth words of the first sub frame, the third to tenth words of the second sub frame, and the third to tenth words of the third sub frame is predetermined data required for the calculation of the position of the satellite 2 and the distance from the satellite 2, and corresponds to the above-described “positioning data”.

Returning to the description of FIG. 1, the positioning unit 10 generates NMEA data including a variety of information such as the location information and time information of the positioning result, the number of captures of the satellite 2, and the reception status such as the strength of the satellite signal, and outputs it to the control unit 20. NMEA is an abbreviation for National Marine Electronics Association. Further, in this embodiment, the positioning unit 10 generates decode status information RDC that is information relating to the decode status of positioning data, and outputs it to the control unit 20. For example, the positioning unit 10 generates NMEA data and the decode status information RDC every second, and outputs them to the control unit 20.

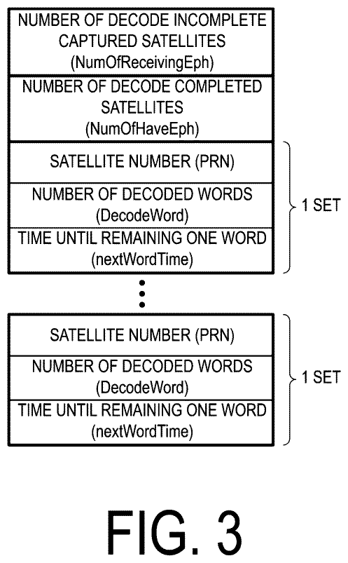

FIG. 3 is a diagram illustrating an example of a configuration of the decode status information RDC. In the example illustrated in FIG. 3, the decode status information RDC includes the number of decode incomplete captured satellites NumOfReceivingEph. The number of decode incomplete captured satellites NumOfReceivingEph is the number of the satellites 2 whose decode of at least a part of the word of the positioning data included in satellite signal is incomplete among the satellites 2 captured by the positioning unit 10. In addition, the decode status information RDC includes the number of decode completed satellites NumOfHaveEph. The number of decode completed satellites NumOfHaveEph is the number of the satellites 2 whose decode of all words of the positioning data included in the satellite signal is completed among the satellites 2 captured by the positioning unit 10.

In addition, the decode status information RDC includes a set of a satellite number PRN, the number of decoded words DecodeWord and a time until one word left nextWordTime for each satellite 2 counted to the number of decode incomplete satellites NumOfReceivingEph or the number of decode completed satellites NumOfHaveEph. Specifically, the number of the sets is equal to the sum of the number of decode incomplete captured satellites NumOfReceivingEph and the number of decode completed satellites NumOfHaveEph. The satellite number PRN is a unique number assigned to each satellite 2 in advance. The number of decoded words DecodeWord is the number of words which are included in the positioning data and the decode of which has been completed. The time until one word left nextWordTime is the estimated decoding time expected for the one word left to be decoded in the case where the decoding of the positioning data is completed with the one word left. For the satellite 2 whose decode of all words has been completed and the satellite 2 whose decode of two or more words is incomplete, nextWordTime is set to “−1”, for example.

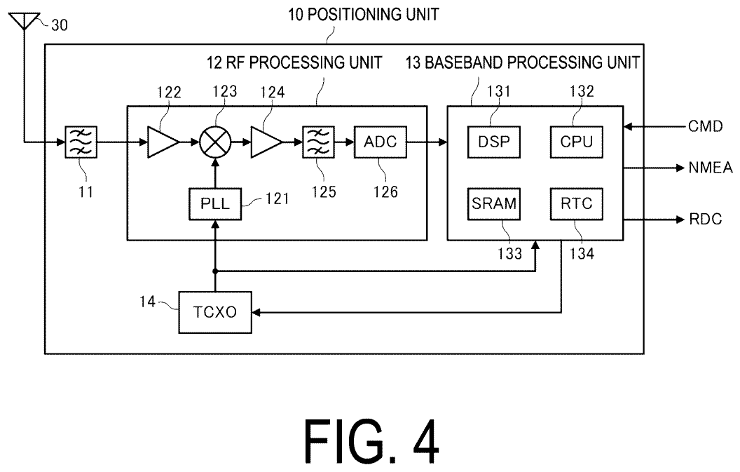

FIG. 4 is a diagram illustrating an example of a configuration of the positioning unit 10. As illustrated in FIG. 4, the positioning unit 10 includes a SAW filter 11, an RF processing unit 12, a baseband processing unit 13 and a TCXO 14. SAW is an abbreviation for Surface Acoustic Wave. RF is an abbreviation for Radio Frequency. TCXO is an abbreviation for Temperature Compensated Crystal Oscillator. It should be noted that the positioning unit 10 may have a configuration in which some of these components are omitted or changed, or a configuration with other components added to the components.

The SAW filter 11 performs a process of extracting satellite signals from the radio waves received by the antenna 30. Specifically, the SAW filter 11 is configured as a bandpass filter that passes signals of a 1.5 GHz band.

The RF processing unit 12 includes a PLL 121, a LNA 122, a mixer 123, an IF amplifier 124, an IF filter 125 and an ADC 126. PLL is an abbreviation for Phase Locked Loop. LNA is an abbreviation for Low Noise Amplifier. IF is an abbreviation for Intermediate Frequency. ADC is an abbreviation for Analog to Digital Converter. It should be noted that the RF processing unit 12 may have a configuration in which some of these components are omitted or changed, or a configuration with other components added to the components.

The PLL 121 generates a clock signal by multiplying the oscillation signal of the TCXO 14 that oscillates at about several tens of MHz, to a frequency in 1.5 GHz band.

The satellite signal extracted by the SAW filter 11 is amplified by the LNA 122. The satellite signal amplified by the LNA 122 is mixed with the clock signal output by the PLL 121 at the mixer 123 and down-converted to an IF signal in an intermediate frequency band, e.g., several MHz. The signal mixed at the mixer 123 is amplified at the IF amplifier 124.

Through the mixing at the mixer 123, the GHz-order radio frequency signal is also generated together with the IF signal, and therefore the IF amplifier 124 amplifies this radio frequency signal together with the IF signal. The IF filter 125 passes the IF signal and attenuates this radio-frequency signal to a level below a predetermined level. The IF signal that passes through the IF filter 125 is converted to a digital signal by the ADC 126.

The baseband processing unit 13 includes a DSP 131, a CPU 132, an SRAM 133 and an RTC134, and performs various processes with oscillation signals of the TCXO 14 as clock signals. DSP is an abbreviation for Digital Signal Processor. CPU is an abbreviation for Central Processing Unit. SRAM is an abbreviation of Static Random Access Memory. RTC is an abbreviation for Real Time Clock.

The DSP 131 and the CPU 132 in conjunction with each other demodulate a baseband signal from the IF signal and acquire orbit information and time information included in the navigation message.

The SRAM 133 is for storing the acquired time information, orbit information and the like. The RTC134 is for generating the timing for performing the baseband process. The RTC134 is counted up with the clock signal from the TCXO 14.

More specifically, the baseband processing unit 13 generates a local code with the same pattern as each C/A code, and performs satellite search that is a process of correlating the local code and each C/A code included in the baseband signal. Then, the baseband processing unit 13 adjusts the generation timing of the local code such that the correlation value for each local code has the peak value, and, when the correlation value is equal to or greater than the threshold value, determines that it has synchronized with the satellite 2 whose C/A code is that local code i.e., the satellite 2 has been captured. Note that the GPS employs a CDMA system in which all satellites 2 transmit the same frequency satellite signals using different C/A codes. Thus, the baseband processing unit 13 can search for the satellite 2 that can be captured by determining the C/A code included in the received satellite signal. CDMA is an abbreviation for Code Division Multiple Access.

In addition, to acquire the orbit information and time information of the captured satellite 2, the baseband processing unit 13 performs a process of mixing the baseband signal and the local code with the same pattern as the C/A code of the satellite 2. The mixed signal is demodulated with a navigation message including the time information and the orbit information of the captured satellite 2. Then, the baseband processing unit 13 performs a process of acquiring the time information and the orbit information included in the navigation message, and storing it in the SRAM 133.

In addition, the baseband processing unit 13 performs positioning using the orbit information and the time information of four or more satellites 2 stored in the SRAM 133. Then, the baseband processing unit 13 generates NMEA data including a variety of information such as the location information and time information of the positioning result, the number of captures of the satellite 2, and the reception status such as the strength of the satellite signal, and outputs it to the control unit 20. Further, the baseband processing unit 13 generates the above-described decode status information RDC and outputs it to the control unit 20.

Returning to the description of FIG. 1, the control unit 20 controls the operation of the positioning unit 10 by transmitting various control commands CMD to the positioning unit 10, and performs various processes by receiving the decode status information RDC and the NMEA data output from the positioning unit 10. The control unit 20 may perform the various processes in accordance with the programs stored in the storage unit 50, for example.

The positioning unit 10 needs to perform high speed and complicated computation, and therefore it is desirable to shorten the drive time of the positioning unit 10 as much as possible because the consumption of the power supplied from the battery 40 is large. In view of this, to reduce the power consumption, the control unit 20 drives the positioning unit 10 intermittently in a predetermined cycle to perform positioning. For example, the cycle of the intermittent drive is set in advance to an appropriate time, e.g., as short a time as possible within a range that satisfies the requested acquisition frequency of the location information. The control unit 20 may control the intermittent drive of the positioning unit 10 by controlling whether the power supply from the battery 40 to the positioning unit 10 is performed or stopped.

Further, to reduce the power consumption, the control unit 20 sets the timeout time for stopping the positioning by the positioning unit 10. The timeout time is set in advance to an appropriate time shorter than the cycle of the intermittent drive in accordance with the requested continuation operation period of the positioning apparatus 1, the capacity of the battery 40 and the like. The timeout time may be a fixed value, or may be set to any values from the outside of the positioning apparatus 1. The control unit 20 transmits to the positioning unit 10 a predetermined control command CMD in a predetermined cycle to start positioning, and when the positioning is not completed even after the elapse of the timeout time, transmits to the positioning unit a predetermined control command CMD to stop the positioning.

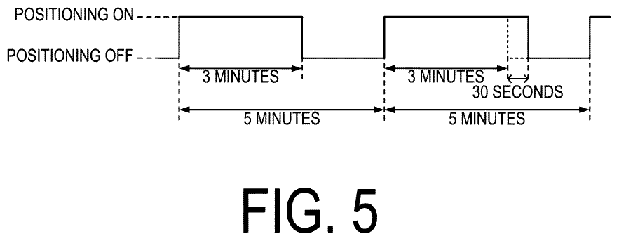

It should be noted that when it is estimated that the positioning by the positioning unit 10 will be completed if the positioning by the positioning unit 10 is further continued by a predetermined time at the timeout time, the control unit 20 may cause the positioning unit 10 to continue the positioning by extending the time by the predetermined time. FIG. 5 illustrates an example of the cycle of the intermittent drive of the positioning unit 10, the timeout time of the positioning and the extension time of the positioning. In the example illustrated in FIG. 5, the cycle of the intermittent drive is set to 5 minutes, and the timeout time is set to 3 minutes. The first positioning is completed within the timeout time, while the second positioning is not completed within the timeout time and an extension time of 30 seconds is set.

In this embodiment, the control unit 20 controls the positioning unit 10 regarding whether to continue or stop the positioning on the basis of the decode completion rate of the positioning data by the positioning unit 10. In this embodiment, the control unit 20 calculates the decode completion rate of the positioning data by the positioning unit 10 on the basis of the decode status information RDC output from the positioning unit 10. For example, the decode completion rate can be calculated as a percentage by dividing the number of decoded words DecodeWord for the satellite 2 with a given satellite number PRN included in the decode status information RDC, by the total number of words of the positioning data, and multiplying it by 100. For example, when the number of decoded words DecodeWord is 20 and the total number of words of the positioning data is 20, the decode completion rate is 100%. In addition, for example, when the number of decoded words DecodeWord is 10 and the total number of words of the positioning data is 20, the decode completion rate is 50%.

At the timeout time, when there are a predetermined number or more of satellites 2 whose decode completion rate of the positioning data is equal to or greater than a predetermined rate, the control unit 20 causes the positioning unit 10 to continue the positioning, whereas when the number of the satellite 2 whose decode completion rate is equal to or greater than the predetermined rate is smaller than the predetermined number, the control unit 20 causes the positioning unit 10 to stop the positioning. The predetermined number is a number equal to or greater than the minimum necessary number of the satellites 2 for the positioning. In addition, the predetermined rate may be 70%, for example. Specifically, at the timeout time, when there are a predetermined number or more of the satellites 2 whose decode completion rate is 70% or greater, the control unit 20 may cause the positioning unit 10 to continue the positioning, whereas when the number of the satellites 2 whose decode completion rate is 70% or greater is smaller than the predetermined number, the control unit 20 may cause the positioning unit 10 to stop the positioning. In addition, at the timeout time, when the number of the satellites 2 whose decode completion rate of the positioning data is 100% is equal to the number obtained by subtracting 1 from the predetermined number, and there is the satellite 2 whose decode of the positioning data is completed by one word left, the control unit 20 may cause the positioning unit 10 to continue the positioning for the time until the one word left is received next or longer. For example, when the one word left is the tenth word of the third sub frame immediately after completion of reception of the data of the tenth word of the fifth sub frame at the timeout time, the time until the tenth word of the third sub frame is received next is 18 seconds, and therefore the control unit 20 may cause the positioning unit 10 to continue the positioning for 18 seconds or longer. The control unit 20 can determine the time until the reception of the one word left with nextWordTime included in the decode status information RDC. nextWordTime represents the shortest time until the one word left is received at the earliest from the satellite 2 in the case where the number of decoded words DecodeWord is smaller by 1 than the total number of words of the positioning data, for each captured satellite 2. For example, in the case where the satellite system to which the satellite 2 belongs is a GPS, nextWordTime is calculated as time information from 1 to 30 seconds from the word information of the navigation data that is being currently received at the positioning unit 10 synchronized in time with the satellite 2.

The control unit 20 also performs various processes corresponding to operation signals from the operation unit 70, a process of controlling the communication unit 60 for performing data communication with the outside, a process of transmitting display signals for causing the display unit 80 to display various information, and the like.

The operation unit 70 is an input device composed of an operation key, a button switch and the like, and transmits an operation signal corresponding to the operation by the user to the control unit 20.

The storage unit 50 stores programs and data for the control unit 20 to perform various calculation processes and control processes, and the like. The storage unit 50 is also used as a work area of the control unit 20, and temporary stores data input from the operation unit 70, results of computation executed by the control unit 20 in accordance with various programs, and the like.

The communication unit 60 performs various controls for establishing data communication between the control unit 20 and an external apparatus not illustrated in the drawing.

The display unit 80 is a display device composed of an LCD or the like, and displays various information based on display signals input from the control unit 20. LCD is an abbreviation for Liquid Crystal Display. The display unit 80 may be provided with a touch panel that functions as the operation unit 70.

The positioning apparatus 1 may be various devices, including an exercise support terminal that supports user's exercise, and a monitoring terminal that monitors user's activities, for example. For example, in the case where the positioning apparatus 1 is an exercise support terminal, the control unit 20 may generate an image of a movement trajectory of the positioning apparatus 1 in an overlaid manner on a map on the basis of location information and time information included in NMEA data output from the positioning unit 10 so as to cause the display unit 80 to display it. In addition, for example, in the case where the positioning apparatus 1 is a monitoring terminal, the control unit 20 may detect user's abnormal actions or stops on the basis of location information and time information included in NMEA data output from the positioning unit 10 so as to cause the display unit 80 to display alert information or transmit it to other terminals through the communication unit 60.

### 1-2. Procedure of Generation of Decode Status Information by Positioning Unit

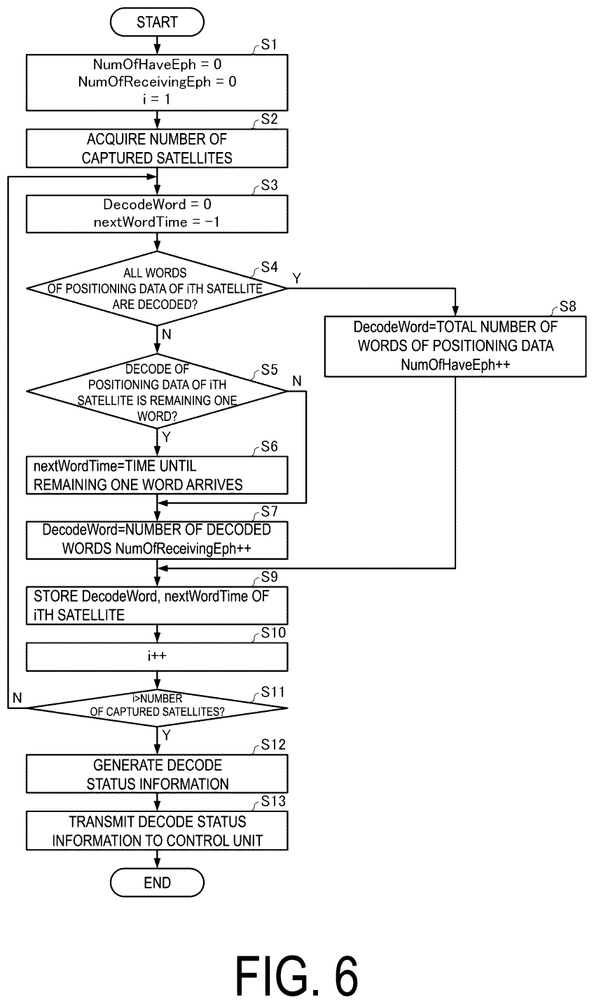

FIG. 6 is a flowchart illustrating an example of a generation procedure of the decode status information RDC by the positioning unit 10. As illustrated in FIG. 6, first, at step S1, the positioning unit 10 sets 0 to each of the number of decode completed satellites NumOfHaveEph and the number of decode incomplete captured satellites NumOfReceivingEph, and 1 to variable i.

Next, at step S2, the positioning unit 10 acquires the number of captured satellites that is the number of captured satellites 2.

Next, at step S3, the positioning unit 10 sets 0 to the number of decoded words DecodeWord, and −1 to the time until one word left nextWordTime.

Next, at step S4, the positioning unit 10 determines whether all words of the positioning data of the ith satellite 2 of captured the satellites 2 are decoded. When at least one word of the positioning data of the ith satellite 2 is not decoded at step S4, then the positioning unit 10 determines whether the decode of the positioning data of the ith satellite 2 is for the one word left at step S5.

At step S5, when the decode of the positioning data of the ith satellite 2 is for the one word left, then the positioning unit 10 set to nextWordTime the time [sec] until the one word left arrives at step S6. At step S5, when the decode of the positioning data of the ith satellite 2 is not for the one word left, the positioning unit 10 does not perform the process of step S6.

Next, at step S7, the positioning unit 10 sets the number of decoded words to DecodeWord, and adds 1 to NumOfReceivingEph.

On the other hand, at step S4, when all words of the positioning data of the ith satellite 2 have been decoded, then the positioning unit 10 sets the total number of words of the positioning data to DecodeWord, and adds 1 to NumOfHaveEph.

Next, at step S9, the positioning unit 10 stores nextWordTime and DecodeWord of the ith satellite 2.

Next, at step S10, the positioning unit 10 adds 1 to variable i. Then, at step S11, when variable i is equal to or smaller than the number of captured satellites acquired at step S2, the positioning unit 10 repeats the processes of steps S3 to S10 until variable i becomes greater than the number of captured satellites.

At step S11, when variable i becomes greater than the number of captured satellites, then at step S12 the positioning unit 10 generates the decode status information RDC including NumOfHaveEph, NumOfReceivingEph and DecodeWord and nextWordTime of each satellite 2 stored at step S9.

Finally, at step S13, the positioning unit 10 transmits the decode status information RDC generated at step S12 to the control unit 20, and then terminates the generation process of the decode status information RDC.

### 1-3. Procedure of Positioning Control by Control Unit

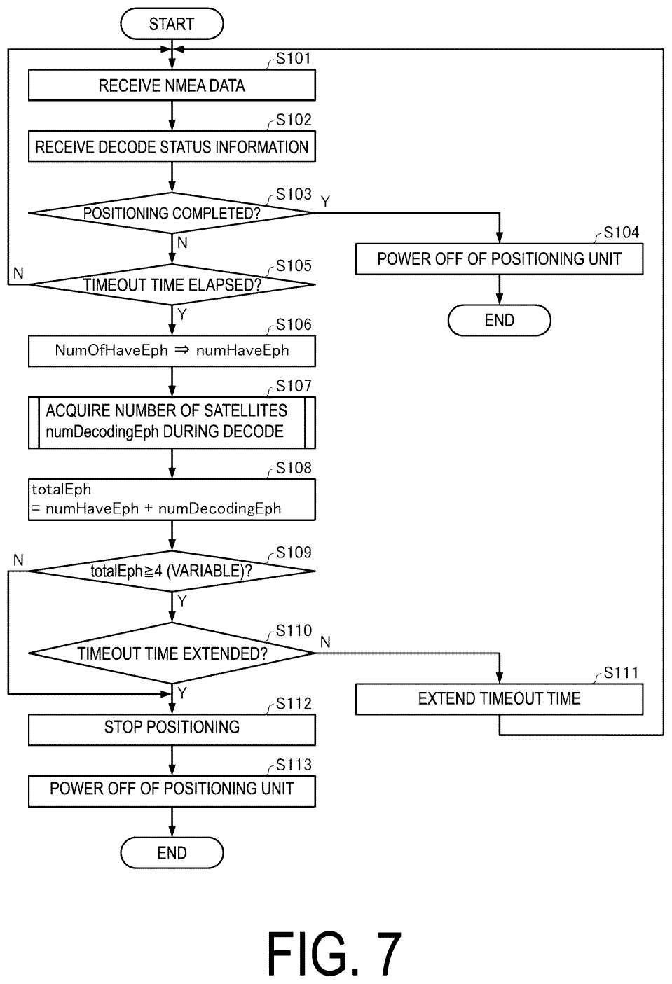

FIG. 7 is a flowchart illustrating an example of a procedure of a positioning control by the control unit 20 of the first embodiment. As illustrated in FIG. 7, first, at step S101, the control unit 20 receives the NMEA data sent from the positioning unit 10.

Next, at step S102, the control unit 20 receives the decode status information RDC sent from the positioning unit 10.

Next, at step S103, the control unit 20 determines whether the positioning by the positioning unit 10 has been completed. For example, when location information is included in the NMEA data received at step S101, the control unit 20 may determine that the positioning has been completed.

At step S103, when the positioning by the positioning unit 10 has been completed, the control unit 20 terminates the positioning control by turning off the power of the positioning unit 10 at step S104.

On the other hand, when the positioning by the positioning unit 10 has not been completed at step S103, the control unit 20 determines whether the timeout time has elapsed at step S105. When the timeout time has not elapsed at step S105, the control unit 20 repeats the processes of steps S101 to S104 until the positioning by the positioning unit 10 is completed or the timeout time elapses.

At step S105, when the timeout time has elapsed before the positioning by the positioning unit 10 is completed, then at step S106 the control unit 20 sets to numHaveEph the value of the number of decode completed satellites NumOfHaveEph included in the decode status information RDC received at step S102.

Next, at step S107, the control unit 20 acquires the number of satellites numDecodingEph during the decode. The numDecodingEph is the number of the satellites 2 whose decode completion rate is equal to or greater than a predetermined rate among the satellites 2 whose decode of positioning data is incomplete. The procedure of the process of step S107 is described later.

Next, at step S108, the control unit 20 sets totalEph to the value of the sum of numHaveEph set at step S106 and numDecodingEph acquired at step S107. The numHaveEph is the number of the satellites 2 whose decode is completed, i.e., the number of the satellites 2 whose decode completion rate is 100%, and therefore totalEph is the number of the satellites 2 whose decode completion rate is equal to or greater than a predetermined rate.

Next, at step S109, the control unit 20 determines whether totalEph set at step S108 is 4 or greater. The value to be compared with totalEph is variable, and is not limited to 4. For example, the value to be compared with totalEph may be set from the outside of the positioning apparatus 1.

At step S109, when totalEph is smaller than 4, the control unit 20 stops the positioning by the positioning unit 10 at step S112. Then, at step S113, the control unit 20 turns off the power of the positioning unit 10, and terminates the positioning control.

On the other hand, when totalEph is equal to or greater than 4 at step S109, the control unit 20 determines whether the timeout time has been extended at step S110. Since the timeout time has not been extended at step S110, the control unit 20 extends the timeout time at step S111. For example, the control unit 20 may extend the timeout time by a predetermined time. Alternatively, when numHaveEph is 3 and there is the satellite 2 whose decode of the positioning data is completed by one word left, the control unit 20 may calculate the time until the one word left is received next, and extend the timeout time by that time or more.

Then, the control unit 20 repeats the processes of steps S101 to S104 until the positioning by the positioning unit 10 is completed, or the extended timeout time elapses. At step S105, when the extended timeout time has elapsed before the positioning by the positioning unit 10 is completed, the control unit 20 again performs processes of steps S106 to S109.

At step S109, when totalEph is equal to or greater than 4, the timeout time has been extended at step S110, and therefore the control unit 20 stops the positioning by the positioning unit 10 at step S112, and turns off the power of the positioning unit 10 at step S113 to terminate the positioning control.

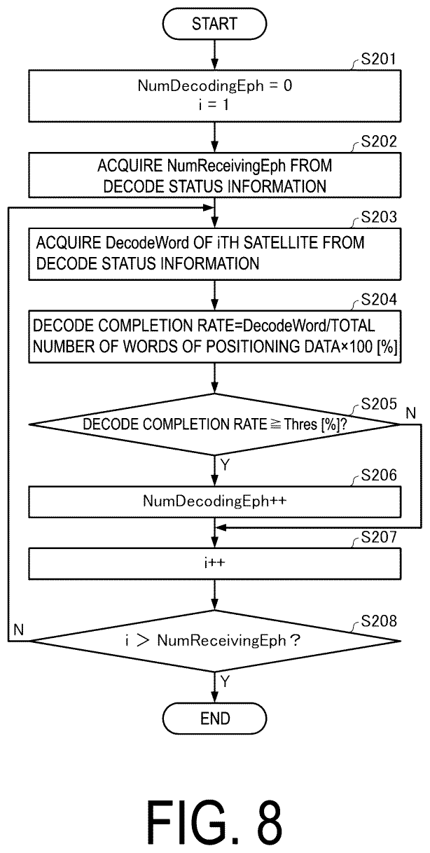

FIG. 8 is a flowchart illustrating an example of a procedure of a process of step S107 of FIG. 7. As illustrated in FIG. 8, first, at step S201, the control unit 20 sets 0 to numDecodingEph, and 1 to variable i.

Next, at step S202, the control unit 20 acquires NumOfReceivingEph from the decode status information RDC received at step S102 of FIG. 7.

Next, at step S203, the control unit 20 acquires DecodeWord of the ith satellite 2 from the decode status information RDC.

Next, at step S204, the control unit 20 calculates the decode completion rate as a percentage by dividing DecodeWord by the total number of words of the positioning data and multiplying it by 100.

Next, at step S205, the control unit 20 determines whether the decode completion rate calculated at step S204 is a predetermined rate Thres [%] or greater. The predetermined rate Thres may be 70%, for example.

At step S205, when the decode completion rate is equal to or greater than Thres [%], the control unit 20 adds 1 to numDecodingEph at step S206. At step S205, when the decode completion rate is smaller than Thres [%], the control unit 20 does not perform the process of step S206.

Next, at step S207, the control unit 20 adds 1 to variable i. Then, at step S208, when variable i is equal to or smaller than the value of NumOfReceivingEph acquired at step S202, the control unit 20 repeats the processes of steps S203 to S207 until variable i becomes greater than the value of NumOfReceivingEph.

At step S208, when variable i becomes greater than the value of NumOfReceivingEph, the control unit 20 terminates the process of step S107 of FIG. 7.

In this manner, in the procedure illustrated in FIGS. 7 and 8, when there are four or more satellites 2 whose decode completion rate [%] of the positioning data is equal to or greater than a predetermined rate, e.g., 70% at the time when the timeout time has elapsed while the positioning by the positioning unit 10 is not completed, the positioning by the positioning unit 10 is expected to be completed in a little more time, and therefore the control unit 20 extends the timeout time and causes the positioning unit 10 to continue the positioning. On the other hand, when the number of the satellites 2 whose decode completion rate [%] of the positioning data is equal to or greater than a predetermined rate is smaller than four at the time when the timeout time has elapsed, the possibility of completion of the positioning by the positioning unit 10 is low even when the timeout time is extended, and therefore the control unit 20 causes the positioning unit 10 to stop the positioning. As a result, the positioning unit 10 can efficiently generate the location information while reducing the power consumption of the positioning unit 10.

### 1-4. Operations and Effects

As described above, with the positioning apparatus 1 of the first embodiment, the control unit 20 appropriately controls the continuation or stop of the positioning by the positioning unit 10 on the basis of the decode completion rate of the positioning data that differs depending on the communication state with the satellite 2, and thus the power consumed by the positioning can be reduced.

In addition, with the positioning apparatus 1 of the first embodiment, at the timeout time, when the decode of the positioning data of equal to or more than a predetermined number of satellites 2 is expected to be completed in a little more time, the control unit 20 continues the positioning by the positioning unit 10, and thus location information can be efficiently acquired.

### 2. Second Embodiment

The positioning apparatus 1 of a second embodiment is described below, and the same components as those of the first embodiment are denoted with the same reference numerals. The same description as that of the first embodiment is omitted or simplified, and differences from the first embodiment are mainly described.

The configuration of the positioning apparatus 1 of the second embodiment is the same as that of FIG. 1, and therefore the illustration is omitted. The positioning apparatus 1 of the second embodiment is different from the first embodiment in the positioning control process by the control unit 20.

In the second embodiment, as in the first embodiment, the control unit 20 controls the positioning unit 10 regarding whether to continue or stop the positioning on the basis of the decode completion rate of the positioning data by the positioning unit 10. It should be noted that in the second embodiment, unlike in the first embodiment, the control unit 20 controls the positioning unit 10 regarding whether to continue or stop the positioning on the basis of the decode completion rate of the positioning data at a predetermined timing corresponding to the satellite system to which the satellite 2 belongs. The predetermined timing may be a timing corresponding to the cycle of the positioning data. For example, as described above, in the case where the satellite system to which the satellite 2 belongs is a GPS, the positioning data is 20-word data composed of the third and eighth to tenth words of the first sub frame, the third to tenth words of the second sub frame and the third to tenth words of the third sub frame included in a main frame that is one unit of the navigation message. As described above, one main frame of a navigation message in the GPS is transmitted from each satellite 2 in 30 seconds, and therefore the cycle of the positioning data is 30 seconds. That is, the predetermined timing is a cycle corresponding to 30 seconds, and when the timeout time is 3 minutes, it may be any one or more of five timings, 30 seconds, 1 minute, 1 minute and 30 seconds, 2 minutes, and 2 minutes and 30 seconds, elapsed after the start of positioning by the positioning unit 10.

In addition, the predetermined timing may be the timing of each round of the positioning data in the satellite signal transmitted from each satellite 2. For example, in the case where the satellite system to which the satellite 2 belongs is a GPS, the predetermined timing may be five timings, 30 seconds, 1 minute, 1 minute and 30 seconds, 2 minutes, and 2 minutes and 30 seconds, elapsed after the start of positioning by the positioning unit 10. Then, the control unit 20 may determine whether there are a predetermined number or more of the satellites 2 whose decode completion rate of the positioning data is 100% at the timeout time set in advance on the basis of the decode completion rate of the positioning data for each timing of each round of the positioning data in the satellite signal transmitted from each satellite 2, and when determining that there are not a predetermined number or more of the satellites 2 whose decode completion rate of the positioning data is 100%, it may cause the positioning unit 10 to stop the positioning.

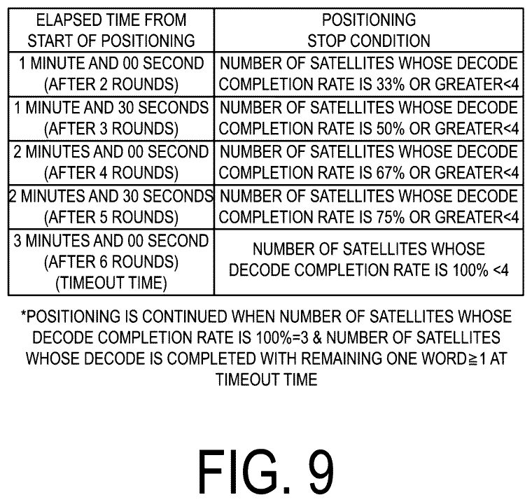

FIG. 9 illustrates an exemplary relationship between the elapsed time from the start of the positioning and the positioning stop condition. In the example illustrated in FIG. 9, the timeout time is set to 3 minutes, and the pace at which the decode completion rate becomes 100% at the timeout time is that the decode completion rate after the elapse of 1 minute after the start of the positioning is 33%, the decode completion rate after the elapse of 1 minute and 30 seconds is 50%, the decode completion rate after the elapse of 2 minutes is 67%, and the decode completion rate after the elapse of 2 minutes and 30 seconds is 75%.

Thus, when the number of the satellites 2 whose decode completion rate is 33% or greater is smaller than four at the time of the elapse of 1 minute after the start of the positioning, the control unit 20 determines that there are not four or more satellites 2 whose decode completion rate is 100% at the timeout time, and causes the positioning unit 10 to stop the positioning. In addition, when the number of the satellites 2 whose decode completion rate is 50% or greater is smaller than four at the time of the elapse of 1 minute and 30 seconds after the start of the positioning, the control unit 20 determines that there are not four or more satellites 2 whose decode completion rate is 100% at the timeout time, and causes the positioning unit 10 to stop the positioning. In addition, when the number of the satellites 2 whose decode completion rate is 67% or greater is smaller than four at the time of the elapse of 2 minutes after the start of the positioning the control unit 20 determines that there are not four or more satellites 2 whose decode completion rate is 100% at the timeout time, and causes the positioning unit 10 to stop the positioning. In addition, when the number of the satellites 2 whose decode completion rate is 75% or greater is smaller than four at the time of the elapse of 2 minutes and 30 seconds after the start of the positioning, the control unit 20 determines that there are not four or more satellites 2 whose decode completion rate is 100% at the timeout time, and causes the positioning unit 10 to stop the positioning.

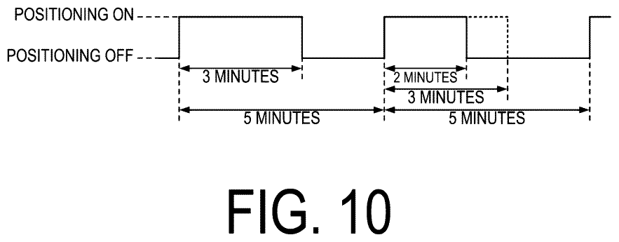

FIG. 10 illustrates an example of the cycle of the intermittent drive of the positioning unit 10, the timeout time of the positioning and the positioning stop timing. In the example illustrated in FIG. 10, the cycle of the intermittent drive is set to 5 minutes, and the timeout time is set to 3 minutes. The first positioning is completed within the timeout time, and the second positioning is stopped after the elapse of 2 minutes.

Note that when the number of the satellites 2 whose decode completion rate is 100% is smaller than four at the timeout time after the elapse of 3 minutes from the start of the positioning, the control unit 20 causes the positioning unit 10 to stop the positioning. It should be noted that at the timeout time, when the number of the satellites 2 whose decode completion rate is 100% is three and the number of the satellites 2 whose decode is completed with the one word left is equal to or greater than one, the control unit 20 may cause the positioning unit 10 to continue the positioning. Specifically, as in the first embodiment, at the timeout time, when the number of the satellites 2 whose decode completion rate of the positioning data is 100% is equal to the number obtained by subtracting 1 from the predetermined number, and there is the satellite 2 whose decode of the positioning data is completed by one word left, the control unit 20 may calculate the time until the one word left is received next, and cause the positioning unit 10 to continue the positioning for more than that time.

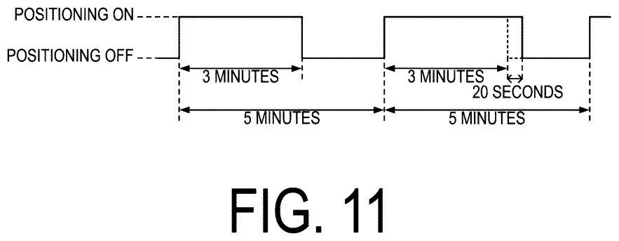

FIG. 11 illustrates an example of the cycle of the intermittent drive of the positioning unit 10, the timeout time of the positioning and the extension time of the positioning. In the example illustrated in FIG. 11, the cycle of the intermittent drive is set to 5 minutes, and the timeout time is set to 3 minutes. The first positioning is completed within the timeout time, while the second positioning is not completed within the timeout time, and 20-second extension time until the reception of the one word left is set.

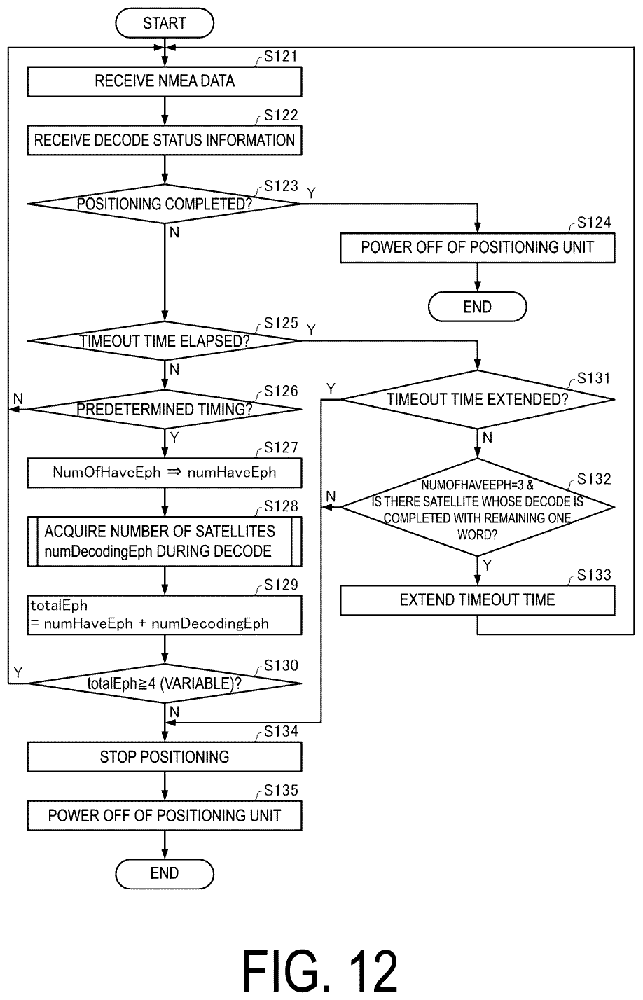

FIG. 12 is a flowchart illustrating an example of a positioning control procedure of the control unit 20 of the second embodiment. As illustrated in FIG. 12, first, at step S121, the control unit 20 receives NMEA data sent from the positioning unit 10.

Next, at step S122, the control unit 20 receives the decode status information RDC sent from the positioning unit 10.

Next, at step S123, the control unit 20 determines whether the positioning by the positioning unit 10 has been completed. For example, when the NMEA data received at step S121 includes location information, the control unit 20 may determine that the positioning has been completed.

At step S123, when the positioning by the positioning unit 10 has been completed, the control unit 20 turns off the power of the positioning unit 10, and terminates the positioning control at step S124.

On the other hand, at step S123, when the positioning by the positioning unit 10 has not been completed, the control unit 20 determines whether the timeout time has elapsed at step S125. At step S125, when the timeout time has not elapsed, the control unit 20 determines whether the predetermined timing has arrived at step S126.

At step S126, when the predetermined timing has not arrived, the control unit 20 repeats the processes of steps S121 to S125 until the positioning by the positioning unit 10 is completed or the timeout time elapses, or, the predetermined timing has arrived.

At step S126, when the predetermined timing has arrived, then at step S127 the control unit 20 sets to numHaveEph the value of the number of decode completed satellites NumOfHaveEph included in the decode status information RDC received at step S122.

Next, at step S128, the control unit 20 acquires the number of satellites numDecodingEph during the decode. The numDecodingEph is the number of the satellites 2 whose decode completion rate is equal to or greater than a predetermined rate that is set in accordance with the elapsed time from the start of the positioning among the satellites 2 whose decode of positioning data is incomplete. The procedure of the process of step S128 is described later.

Next, at step S129, the control unit 20 sets totalEph to the value of the sum of numHaveEph set at step S127 and numDecodingEph acquired at step S128. The numHaveEph is the number of the satellites 2 whose decode is completed, i.e., the number of the satellites 2 whose decode completion rate is 100%, and therefore totalEph is the number of the satellites 2 whose decode completion rate is equal to or greater than a predetermined rate that is set in accordance with the elapsed time from the start of the positioning.

Next, at step S130, the control unit 20 determines whether totalEph set at step S129 is 4 or greater. The value to be compared with totalEph is variable, and is not limited to 4. For example, the value to be compared with totalEph may be set from the outside of the positioning apparatus 1.

At step S130, when totalEph is smaller than 4, the control unit 20 stops the positioning by the positioning unit 10 at step S134. Then, at step S135, the control unit 20 turns off the power of the positioning unit 10, and terminates the positioning control.

At step S130, when totalEph is equal to or greater than 4, the control unit 20 repeats the processes of steps S121 to S129 until the positioning by the positioning unit 10 is completed or the timeout time elapses, or, totalEph becomes smaller than 4.

On the other hand, at step S125, when the timeout time has elapsed, the control unit 20 determines whether the timeout time has been extended at step S131. At step S131, the timeout time has not been extended, and therefore at step S132 the control unit 20 determines whether NumOfHaveEph is 3, and there is the satellite 2 whose decode of the positioning data is completed by one word left on the basis of the decode status information RDC received at step S122.

When the condition of step S132 is not satisfied, the control unit 20 stops the positioning by the positioning unit 10 at step S134, and turns off the power of the positioning unit 10 and terminates the positioning control at step S135.

On the other hand, when the condition of step S132 is satisfied, the control unit 20 extends the timeout time at step S133. More specifically, the control unit 20 may calculate the time until the one word left is received next, and extend the timeout time by that time or more.

Then, the control unit 20 repeats the processes of steps S121 to S124 until the positioning by the positioning unit 10 is completed, or the extended timeout time elapses. At step S125, when the extended timeout time has elapsed before the positioning by the positioning unit 10 is completed, the timeout time has been extended, and therefore the control unit 20 stops the positioning by the positioning unit 10 at step S134, and turns off the power of the positioning unit 10, and terminates the positioning control at step S135.

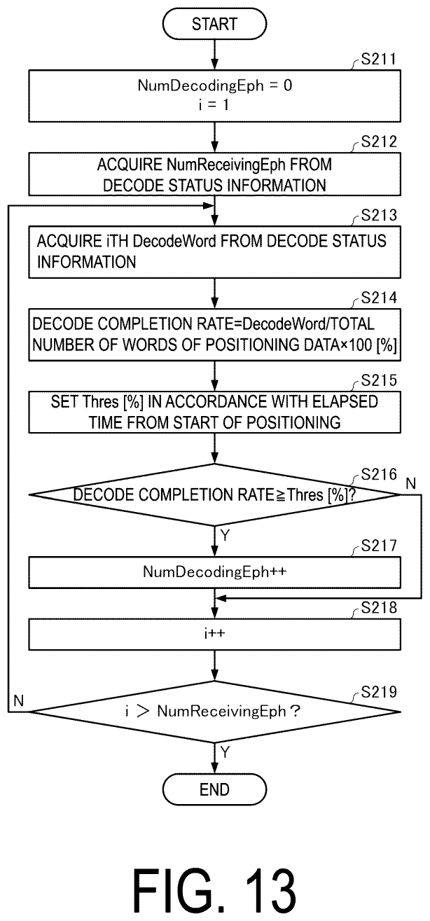

FIG. 13 is a flowchart illustrating an example of a procedure of a process of step S128 of FIG. 12. As illustrated in FIG. 13, first, at step S211, the control unit 20 sets 0 to numDecodingEph, and 1 to variable i.

Next, at step S212, the control unit 20 acquires NumOfReceivingEph from the decode status information RDC received at step S122 of FIG. 12.

Next, at step S213, the control unit 20 acquires DecodeWord of the ith satellite 2 from the decode status information RDC.

Next, at step S214, the control unit 20 calculates the decode completion rate as a percentage by dividing DecodeWord by the total number of words of the positioning data and multiplying it by 100.

Next, at step S215, the control unit 20 sets a predetermined rate Thres [%] in accordance with the elapsed time from the start of the positioning. In the above-described example illustrated in FIG. 9, the predetermined rate Thres is set to one of 33%, 50%, 67% and 75% in accordance with the elapsed time from the start of the positioning.

Next, at step S216, the control unit 20 determines whether the decode completion rate calculated at step S214 is the predetermined rate Thres [%] set at step S215 or greater.

At step S216, when the decode completion rate is equal to or greater than Thres [%], the control unit 20 adds 1 to numDecodingEph at step S217. At step S216, when the decode completion rate is smaller than Thres [%], the control unit 20 does not perform the process of step S217.

Next, at step S218, the control unit 20 adds 1 to variable i. Then, at step S219, when variable i is equal to or smaller than the value of NumOfReceivingEph acquired at step S212, the control unit 20 repeats the processes of steps S213 to S218 until variable i becomes greater than the value of NumOfReceivingEph.

At step S219, when variable i becomes greater than the value of NumOfReceivingEph, the control unit 20 terminates the process of step S128 of FIG. 12.

In this manner, in the procedure illustrated in FIGS. 12 and 13, each time the predetermined timing has arrived from the start of the positioning, when the number of the satellites 2 whose decode completion rate [%] of the positioning data is equal to or greater than the predetermined rate in accordance with the elapsed time from the start of the positioning is smaller than four, the control unit 20 determines that the possibility that the positioning is completed within the timeout time is low and causes the positioning unit 10 to stop the positioning. On the other hand, when the decode of the positioning data of the remaining one satellite 2 is completed by the one word left at the time when the timeout time has elapsed while the positioning by the positioning unit 10 is not completed, the positioning by the positioning unit 10 is expected to be completed in a little more time, and therefore the control unit 20 extends the timeout time for the time until the one word left is received next or longer, and causes the positioning unit 10 to continue the positioning. As a result, the positioning unit 10 can efficiently generate the location information while reducing the power consumption of the positioning unit 10.

The above-described positioning apparatus 1 of the second embodiment achieves an effect similar to that of the positioning apparatus 1 of the first embodiment.

Further, with the positioning apparatus 1 of the second embodiment, the control unit 20 can appropriately control continuation or stop of the positioning by the positioning unit 10 at an appropriate timing corresponding to the satellite system to which the satellite 2 belongs.

In addition, with the positioning apparatus 1 of the second embodiment, the control unit 20 can appropriately control continuation or stop of the positioning by the positioning unit 10 on the basis of a highly accurate decode completion rate at a predetermined timing corresponding to the cycle of the positioning data.

In addition, with the positioning apparatus 1 of the second embodiment, the control unit 20 can control continuation or stop of the positioning by the positioning unit 10 at the timing of each round of the positioning data, and thus the power consumption of the positioning by the positioning unit 10 can be optimized.

In addition, with the positioning apparatus 1 of the second embodiment, the control unit 20 can stop the positioning by the positioning unit 10 when the decode of the positioning data of equal to or more than a predetermined number of satellites 2 is not expected to be completed within the timeout time at the timing of each round of the positioning data of each satellite 2, and thus the power consumption of the positioning by the positioning unit 10 can be reduced.

In addition, with the positioning apparatus 1 of the second embodiment, when the decode of the positioning data of equal to or more than a predetermined number of satellites 2 is expected to be completed in a little more time at the timeout time, the control unit 20 continues the positioning by the positioning unit 10, and thus location information can be efficiently acquired.

### 3. Third Embodiment

The positioning apparatus 1 of a third embodiment is described below, and the same components as those of the first and second embodiments are denoted with the same reference numerals. The same description as that of the first and second embodiments is omitted or simplified, and differences from the first and second embodiments are mainly described.

Also in the third embodiment, as in the first and second embodiments, the control unit 20 controls the positioning unit 10 regarding whether to continue or stop the positioning on the basis of the decode completion rate of the positioning data by the positioning unit 10. In addition, in the third embodiment, as in the second embodiment, the control unit 20 controls the positioning unit 10 regarding whether to continue or stop the positioning on the basis of the decode completion rate of the positioning data at a predetermined timing corresponding to the satellite system to which the satellite 2 belongs. The predetermined timing may be a timing corresponding to the cycle of the positioning data. In addition, the predetermined timing may be the timing of each round of the positioning data in the satellite signal transmitted from each satellite 2.

It should be noted that in the third embodiment, unlike in the second embodiment, the control unit 20 sets the timeout time for stopping the positioning on the basis of the remaining quantity of the battery 40, determines whether there are a predetermined number or more of the satellites 2 whose decode completion rate of the positioning data is 100% on the basis of the decode completion rate of the positioning data for each timing of each round of the positioning data in the satellite signal transmitted from each satellite 2, and, when determining that there are not a predetermined number or more of the satellites 2 whose decode completion rate of the positioning data is 100%, causes the positioning unit 10 to stop the positioning.

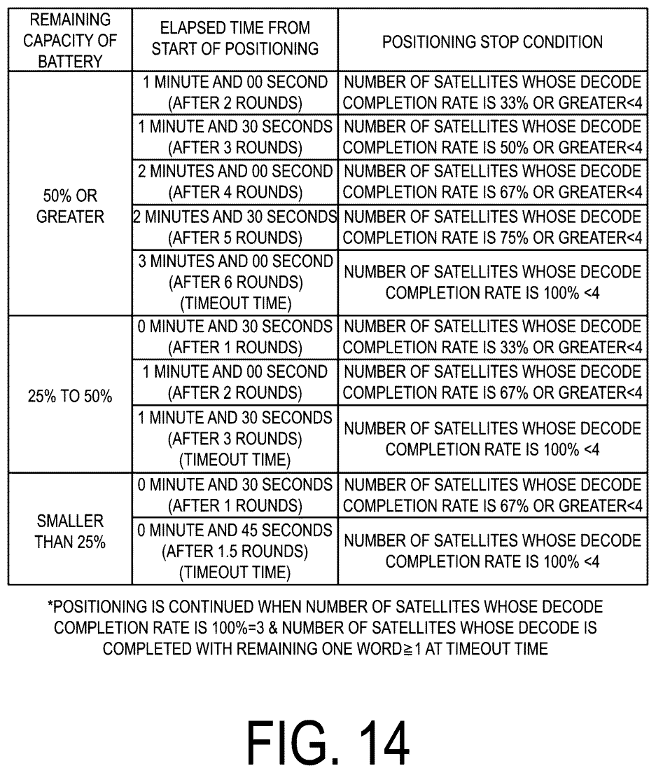

FIG. 14 illustrates an exemplary relationship between the remaining quantity of the battery 40, the elapsed time from the start of the positioning and the positioning stop condition. In the example illustrated in FIG. 14, when the remaining quantity of the battery 40 is 50%, the timeout time is set to 3 minutes, and the pace at which the decode completion rate becomes 100% at the timeout time is that the decode completion rate after the elapse of 1 minute from the start of the positioning is 33%, the decode completion rate after the elapse of 1 minute and 30 seconds is 50%, the decode completion rate after the elapse of 2 minutes is 67%, and the decode completion rate after the elapse of 2 minutes and 30 seconds is 75%. Thus, when the number of the satellites 2 whose decode completion rate is 33% or greater is smaller than four at the time of the elapse of 1 minute after the start of the positioning, the control unit 20 determines that there are not four or more satellites 2 whose decode completion rate is 100% at the timeout time, and causes the positioning unit 10 to stop the positioning. In addition, when the number of the satellites 2 whose decode completion rate is 50% or greater is smaller than four at the time of the elapse of 1 minute and 30 seconds after the start of the positioning, the control unit 20 determines that there are not four or more satellites 2 whose decode completion rate is 100% at the timeout time, and causes the positioning unit 10 to stop the positioning. In addition, when the number of the satellites 2 whose decode completion rate is 67% or greater is smaller than four at the time of the elapse of 2 minutes after the start of the positioning the control unit 20 determines that there are not four or more satellites 2 whose decode completion rate is 100% at the timeout time, and causes the positioning unit 10 to stop the positioning. In addition, when the number of the satellites 2 whose decode completion rate is 75% or greater is smaller than four at the time of the elapse of 2 minutes and 30 seconds after the start of the positioning, the control unit 20 determines that there are not four or more satellites 2 whose decode completion rate is 100% at the timeout time, and causes the positioning unit 10 to stop the positioning.

In the example illustrated in FIG. 14, when the remaining quantity of the battery 40 is equal to or greater than 25% and smaller than 50%, the timeout time is set to 1 minute and 30 seconds, and the pace at which the decode completion rate becomes 100% at the timeout time is that the decode completion rate after the elapse of 30 seconds from the start of the positioning is 33%, and the decode completion rate after the elapse of 1 minute is 67%. Thus, when the number of the satellites 2 whose decode completion rate is 33% or greater is smaller than four at the time of the elapse of 30 seconds from the start of the positioning, the control unit 20 determines that there are not four or more satellites 2 whose decode completion rate is 100% at the timeout time, and causes the positioning unit 10 to stop the positioning. In addition, when the number of the satellites 2 whose decode completion rate is 67% or greater is smaller than four at the time of the elapse of 1 minute after the start of the positioning, the control unit 20 determines that there are not four or more satellites 2 whose decode completion rate is 100% at the timeout time, and causes the positioning unit 10 to stop the positioning.

In the example illustrated in FIG. 14, when the remaining quantity of the battery 40 is smaller than 25%, the timeout time is set to 45 seconds, and the pace at which the decode completion rate becomes 100% at the timeout time is that the decode completion rate after the elapse of 30 seconds from the start of the positioning is 67%. Thus, when the number of the satellites 2 whose decode completion rate is 67% or greater is smaller than four at the time of the elapse of 30 seconds from the start of the positioning, the control unit 20 determines that there are not four or more satellites 2 whose decode completion rate is 100% at the timeout time, and causes the positioning unit 10 to stop the positioning.

Note that when the number of the satellites 2 whose decode completion rate is 100% is smaller than four at the timeout time, the control unit 20 causes the positioning unit 10 to stop the positioning. It should be noted that at the timeout time, when the number of the satellites 2 whose decode completion rate is 100% is three and the number of the satellites 2 whose decode is completed with the one word left is equal to or greater than one, the control unit 20 may cause the positioning unit 10 to continue the positioning. Specifically, as in the first and second embodiments, when the number of the satellites 2 whose decode completion rate of the positioning data is 100% is equal to the number obtained by subtracting 1 from the predetermined number, and there is the satellite 2 whose decode of the positioning data is completed by one word left at the timeout time, the control unit 20 may calculate the time until the one word left is received next, and cause the positioning unit 10 to continue the positioning for more than that time.

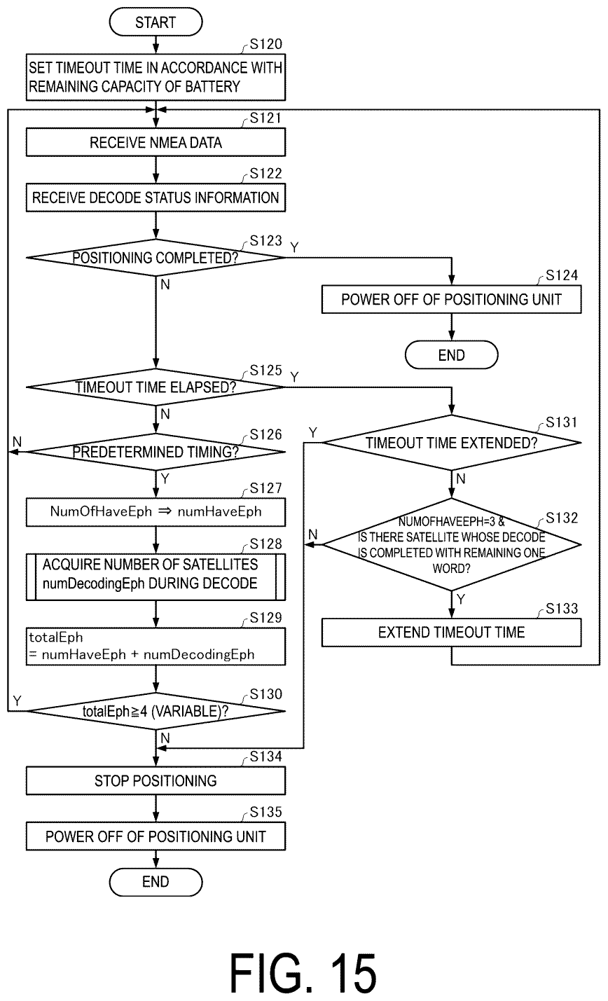

FIG. 15 is a flowchart illustrating an example of a positioning control procedure of the control unit of the third embodiment 20. In FIG. 15, the same processes as those of each step in FIG. 12 are denoted with the same reference numerals.

As illustrated in FIG. 15, first, at step S120, the control unit 20 sets the timeout time for stopping the positioning in accordance with the remaining quantity of the battery 40. Then, the control unit 20 performs processes of steps S121 to S135. Except for the procedure of the process of step S128, the processes of steps S121 to S135 are the same as those of the second embodiment, and therefore their description will be omitted.

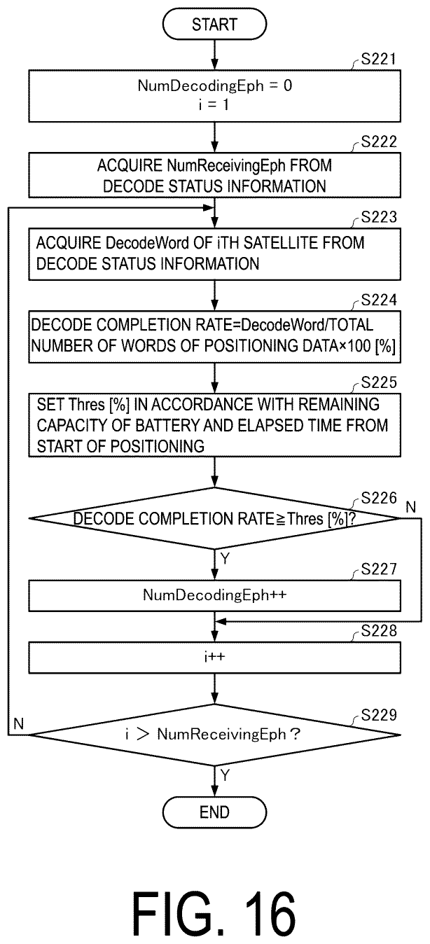

FIG. 16 is a flowchart illustrating an example of a procedure of a process of step S128 of FIG. 15. As illustrated in FIG. 16, first, at step S221, the control unit 20 sets 0 to numDecodingEph, and 1 to variable i.

Next, at step S222, the control unit 20 acquires NumOfReceivingEph from the decode status information RDC received at step S122 of FIG. 15.

Next, at step S223, the control unit 20 acquires DecodeWord of the ith satellite 2 from the decode status information RDC.

Next, at step S224, the control unit 20 calculates the decode completion rate as a percentage by dividing DecodeWord by the total number of words of the positioning data and multiplying it by 100.

Next, at step S225, the control unit 20 sets a predetermined rate Thres [%] in accordance with the remaining quantity of the battery 40 and the elapsed time from the start of the positioning. In the above-described example illustrated in FIG. 14, when the remaining quantity of the battery 40 is 50% or greater, the predetermined rate Thres is set to one of 33%, 50%, 67% and 75% in accordance with the elapsed time from the start of the positioning. In addition, when the remaining quantity of the battery 40 is equal to or greater than 25% and smaller than 50%, the predetermined rate Thres is set to one of 33% and 67% in accordance with the elapsed time from the start of the positioning. In addition, when the remaining quantity of the battery 40 is 25%, the predetermined rate Thres is set to 67% in accordance with the elapsed time from the start of the positioning.

Next, at step S226, the control unit 20 determines whether the decode completion rate calculated at step S224 is the predetermined rate Thres [%] set at step S225 or greater.

At step S226, when the decode completion rate is equal to or greater than Thres [%], the control unit 20 adds 1 to numDecodingEph at step S227. At step S226, when the decode completion rate is smaller than Thres [%], the control unit 20 does not perform the process of step S227.

Next, at step S228, the control unit 20 adds 1 to variable i. Then, at step S229, when variable i acquired at step S222 is equal to or smaller than the value of NumOfReceivingEph, the control unit 20 repeats the processes of steps S223 to S228 until variable i becomes greater than the value of NumOfReceivingEph.

At step S229, when variable i becomes greater than the value of NumOfReceivingEph, the control unit 20 terminates the process of step S128 of FIG. 15.

In this manner, in the procedure illustrated in FIGS. 15 and 16, the control unit 20 sets the timeout time in accordance with the remaining quantity of the battery 40, and when the number of the satellites 2 whose decode completion rate [%] of the positioning data is equal to or greater than a predetermined rate in accordance with the remaining quantity of the battery 40 and the elapsed time from the start of the positioning is smaller than four each time the predetermined timing has arrived from the start of the positioning, the control unit 20 determines that the possibility that the positioning is completed within the timeout time is low and causes the positioning unit 10 to stop the positioning. On the other hand, when the decode of the positioning data of the remaining one satellite 2 is completed by the one word left at the time when the timeout time has elapsed while the positioning by the positioning unit 10 is not completed, the positioning by the positioning unit 10 is expected to be completed in a little more time, and therefore the control unit 20 extends the timeout time for the time until the one word left is received next or longer, and causes the positioning unit 10 to continue the positioning. As a result, the positioning unit 10 can efficiently generate the location information while reducing the power consumption of the positioning unit 10.

The above-described positioning apparatus 1 of the third embodiment can achieve an effect similar to that of the positioning apparatus 1 of the first embodiment.

Further, with the positioning apparatus 1 of the third embodiment, the control unit 20 sets the timeout time set in accordance with the remaining quantity of the battery 40, and can stop the positioning by the positioning unit 10 when the decode of a predetermined number or more pieces of the positioning data is not expected to be completed within the timeout time the timing of each round of the positioning data of each satellite 2, and thus, can optimize the power consumption of the positioning by the positioning unit 10 in accordance with the remaining quantity of the battery 40.

The present invention is not limited to this embodiment, and various variations can be implemented within the scope of the gist of the invention.

Each of the embodiments and variations described above is an example, and is not limited thereto. For example, it is possible to combine each embodiment and variant as appropriate.

The present invention includes configurations substantially identical to the configurations described in the embodiments, e.g., configurations with identical functions, methods and results, or with identical purposes and effects. The invention also includes configurations in which non-essential portions of the configurations described in the embodiments are replaced. The present invention also includes configurations that have the same action effect or can achieve the same purpose as the configurations described in the embodiments. The present invention also includes a configuration in which a known technology is added to the configuration described in the embodiment.

The following contents can be derived from the embodiments and variations described above.

A positioning apparatus according to an aspect includes a positioning unit configured to receive a satellite signal transmitted from each of a plurality of satellites, decode positioning data included in the satellite signal, and perform positioning based on the positioning data decoded, the positioning data being predetermined data required for calculation of a position of the satellite and a distance from the satellite, and a control unit configured to control the positioning unit regarding whether the positioning is continued or stopped, based on a decode completion rate of the positioning data by the positioning unit.

With this positioning apparatus, the control unit appropriately controls continuation or stop of the positioning by the positioning unit on the basis of the decode completion rate of the positioning data that changes in accordance with the communication state with the satellite, and thus the power consumed by the positioning can be reduced.

In the positioning apparatus according to the aspect, when there are a predetermined number or more of satellites the decode completion rate of which is equal to or greater than a predetermined rate at a timeout time set in advance for stopping the positioning, the control unit may cause the positioning unit to continue the positioning.

With this positioning apparatus, at the timeout time, when the decode of the positioning data of the predetermined number or more of the satellites is expected to be completed in a little more time, the control unit causes the positioning unit to continue the positioning, and thus location information can be efficiently acquired.

In the positioning apparatus according to the aspect, the predetermined rate may be 70%.

In the positioning apparatus according to the aspect, at the timeout time, when the number of the satellites the decode completion rate of which is 100% is equal to a number obtained by subtracting 1 from the predetermined number, and there is a satellite of which the positioning data has one word left to be decoded, the control unit may calculate a time until the one word left is received next, and may cause the positioning unit to continue the positioning for a time longer than the calculated time.

With this positioning apparatus, at the timeout time, when the decode of the positioning data of the predetermined number or more of the satellites is expected to be completed in a little more time, the control unit causes the positioning unit to continue the positioning, and thus location information can be efficiently acquired.

In the positioning apparatus according to the aspect, the control unit may control the positioning unit regarding whether the positioning is continued or stopped based on the decode completion rate at a predetermined timing corresponding to a satellite system to which the satellite belongs.

With this positioning apparatus, the control unit can appropriately control the continuation or stop of the positioning by the positioning unit at an appropriate timing corresponding to the satellite system to which the satellite belongs.

In the positioning apparatus according to the aspect, the predetermined timing may be a timing corresponding to a cycle of the positioning data.

With this positioning apparatus, at a predetermined timing, the control unit can appropriately control the continuation or stop of the positioning by the positioning unit on the basis of a highly accurate decode completion rate.

In the positioning apparatus according to the aspect, the predetermined timing may be a timing of each round of the positioning data in the satellite signal.

With this positioning apparatus, the control unit can control the continuation or stop of the positioning by the positioning unit at the timing of each round of the positioning data, and thus the power consumed by the positioning of the positioning unit can be optimized.

In the positioning apparatus according to the aspect, the control unit may determine whether there are a predetermined number or more of satellites the decode completion rate of which is 100% at a timeout time set in advance for stopping the positioning based on the decode completion rate for each timing of each round of the positioning data in the satellite signal, and when the control unit determines that the number of the satellites the decode completion rate of which is 100% is less than the predetermined number, the control unit may cause the positioning unit to stop the positioning.

With this positioning apparatus, the control unit can stop the positioning when the decode of the positioning data of the predetermined number or more of satellites is not expected to be completed by the positioning unit within the timeout time for each timing of each round of the positioning data of each satellite, and thus the power consumed by the positioning by the positioning unit can be reduced.

The positioning apparatus according to the aspect may further include a battery configured to supply power to the positioning unit. The control unit may set a timeout time for stopping the positioning in accordance with a remaining quantity of the battery, determine whether there are a predetermined number or more of satellites the decode completion rate at the timeout time of which is 100% based on the decode completion rate for each of a timing of each round of the positioning data in the satellite signal, and cause the positioning unit to stop the positioning when the control unit determines that the number of the satellites the decode completion rate of which is 100% is less than the predetermined number.

With this positioning apparatus, the control unit sets the timeout time in accordance with the remaining quantity of the battery, and can stop the positioning of the positioning unit when the decode of the positioning data of the predetermined number or more of satellites is not expected to be completed within the timeout time for each the timing of each round of the positioning data of each satellite, and thus the power consumed by the positioning of the positioning unit can be optimized in accordance with the remaining quantity of the battery.

In the positioning apparatus according to the aspect, at the timeout time, when the number of the satellites the decode completion rate of which is 100% is equal to a number obtained by subtracting 1 from the predetermined number, and there is a satellite of which the positioning data has one word left to be decoded, the control unit may calculate a time until the one word left is received next, and may cause the positioning unit to continue the positioning for a time longer than the calculated time.

With this positioning apparatus, at the timeout time, when the decode of the positioning data of the predetermined number or more of the satellites is expected to be completed in a little more time, the control unit causes the positioning unit to continue the positioning, and thus location information can be efficiently acquired.

What is claimed is:

1. A positioning apparatus comprising:
a positioning unit configured to receive a satellite signal transmitted from each of a plurality of satellites, decode positioning data included in the satellite signal, and perform positioning based on the positioning data decoded, the positioning data being predetermined data required for calculation of a position of the satellite and a distance from the satellite; and
a control unit configured to control the positioning unit regarding whether the positioning is continued or stopped, based on a decode completion rate of the positioning data by the positioning unit.

2. The positioning apparatus according to claim 1, wherein when there are a predetermined number or more of satellites the decode completion rate of which is equal to or greater than a predetermined rate at a timeout time set in advance for stopping the positioning, the control unit causes the positioning unit to continue the positioning.

3. The positioning apparatus according to claim 2, wherein the predetermined rate is 70%.

4. The positioning apparatus according to claim 2, wherein at the timeout time, when the number of the satellites, the decode completion rate of which is 100%, is equal to a number obtained by subtracting 1 from the predetermined number, and there is a satellite of which the positioning data has one word left to be decoded, the control unit calculates a time until the one word left is received, and causes the positioning unit to continue the positioning for a time longer than the calculated time.

5. The positioning apparatus according to claim 1, wherein the control unit controls the positioning unit regarding whether the positioning is continued or stopped based on the decode completion rate at a predetermined timing corresponding to a satellite system to which the satellite belongs.

6. The positioning apparatus according to claim 5, wherein the predetermined timing is a timing corresponding to a cycle of the positioning data.

7. The positioning apparatus according to claim 6, wherein the predetermined timing is a timing of each round of the positioning data in the satellite signal.

8. The positioning apparatus according to claim 7, wherein the control unit determines whether there are a predetermined number or more of satellites, the decode completion rate of which is 100% at a timeout time set in advance for stopping the positioning based on the decode completion rate at each timing of each round of the positioning data in the satellite signal, and when the control unit determines that the number of the satellites, the decode completion rate of which is 100%, is less than the predetermined number, the control unit causes the positioning unit to stop the positioning.

9. The positioning apparatus according to claim 7, further comprising a battery configured to supply power to the positioning unit, wherein
the control unit sets a timeout time for stopping the positioning in accordance with a remaining quantity of the battery, determines whether there are a predetermined number or more of satellites, the decode completion rate at the timeout time of which, is 100% based on the decode completion rate for each of a timing of each round of the positioning data in the satellite signal, and causes the positioning unit to stop the positioning when the control unit determines that the number of the satellites, the decode completion rate of which is 100%, is less than the predetermined number.

10. The positioning apparatus according to claim 8, wherein at the timeout time, when the number of the satellites, the decode completion rate of which is 100%, is equal to a number obtained by subtracting 1 from the predetermined number, and there is a satellite of which the positioning data has one word left to be decoded, the control unit calculates a time until the one word left is received, and causes the positioning unit to continue the positioning for a time longer than the calculated time.
